(19) United States
(12) Patent Application Publication
(10) Pub. No.: US 2013/0099763 A1
(43) Pub. Date: Apr. 25, 2013

(54) SYSTEMS AND METHODS FOR SUPPRESSING UNDESIRABLE LIMIT CYCLES IN SWITCHING REGULATORS

(71) Applicant: Emmanouil Terrovitis, Foster City, CA (US)

(72) Inventor: Emmanouil Terrovitis, Foster City, CA (US)

(73) Assignee: Qualcomm Atheros, Inc., San Jose, CA (US)

(21) Appl. No.: 13/278,040

(22) Filed: Oct. 20, 2011

(51) Int. Cl. G05F 1/00

(52) U.S. Cl. 323/271

(57) ABSTRACT

This disclosure involves methods and systems for suppressing undesired limit cycles in switching regulators by determining when a limit cycle causes the inductor to charge for a time greater than the clock period and destabilizing such cycles.

### FIELD OF THE PRESENT INVENTION

The present disclosure generally relates to switching regulators and more particularly to improving performance of current mode pulse width modulated power supplies.

### BACKGROUND OF THE INVENTION

Switching regulators, switching power supplies or switching mode power supplies (SMPS) all refer to an important class of circuits that are widely used to drive sophisticated electronic devices, particularly those depending upon microprocessors. Switching regulators offer high efficiency performance as compared to alternatives such as linear regulators while being able to accommodate rapidly changing loads and relatively high current draws over a wide range of operating conditions.

Switching regulators convert an input voltage to a different output voltage by employing ideally-lossless components such as switches, inductors and capacitors, resulting in high efficiency. Such designs generally feature an inductor switch-connected to the voltage source and an output load. A capacitor is wired in parallel with the output load to smooth the voltage output.

A specific class of switching regulators known as current mode pulse width modulated (PWM) converters are commonly used as they exhibit a number of desirable characteristics, including fast response to changing loads and relatively simple circuit designs. As implied by the name, current mode PWM converters rely on a feedback loop driven by detection of the current flow in the inductor. Voltage regulation is accomplished by a controller that triggers the switch at a relatively high frequency, often in the range of 1 MHz to 5 MHz. The switch is configured to be connected to the inductor at the start of each clock cycle and disconnected when a limiting current is reached in the inductor. An example of the output of this configuration is depicted in FIG. 1, which shows the triangular wave 10 of current build-up and discharge in the inductor. Over the course of a clock cycle, T, current in the inductor charges to a threshold level, Iₗᵢₘ₁ 12, at which point the switch disconnects the inductor from the input voltage and connects it to a second low impedance source such as ground and the current is drawn down, resulting in the average output current, I_{avg} 14.

Although current mode PWM regulators offer good performance, their performance is still subject to improvement. In particular, it is desirable to reduce the voltage ripple exhibited at the output, to minimize the current experienced by the inductor and to diminish problems associated with noise caused by the switching frequency. This invention provides these and other advantages.

### SUMMARY OF THE INVENTION

In accordance with the above objects and those that will be mentioned and will become apparent below, this disclosure is directed to a method for controlling a switching regulator having an inductor coupled to a load and a clock having regular timing cycles T, comprising the steps of determining whether an undesirable limit cycle exists, sending a control signal to switch the inductor to a charge state at a first time during each timing cycle, sensing a current across the inductor, when an undesirable limit cycle does not exist, sending a control signal within one timing cycle from the first time to switch the inductor to a discharge state if the current across the inductor reaches a threshold value, and when an undesirable limit cycle does exist, sending a control signal after at least one timing cycle from the first time to switch the inductor to a discharge state. Preferably, the step of determining whether an undesirable limit cycle exists comprises determining whether the inductor is kept in a charge state for greater than one time cycle T, such as by determining whether the inductor is already switched to a charge state at the first time.

In another aspect of the disclosure, the step of determining whether an undesirable limit cycle exists preferably further comprises determining a period NT of the undesirable limit cycle. In one embodiment, the step of determining the period NT of the undesirable limit cycle comprises counting a number of consecutive timing cycles for which the inductor is already switched to a charge state at the first time of each timing cycle. Preferably, the step of sending a control signal after at least one timing cycle from the first time to switch the inductor to a discharge state includes disabling the sending of the control signal until N−1 timing cycles have occurred.

Yet another aspect of the disclosure is directed to the step of determining whether an undesirable limit cycle exists includes determining when the ratio of a rate during the charge state to a rate during the discharge state is greater than one. In another embodiment, the step of determining whether an undesirable limit cycle exists includes determining whether a time the inductor is in the discharge state is greater than one time cycle.

The disclosure is also directed to a switching regulator comprising an inductor coupled to a load, a clock having regular timing cycles T, a switching system for alternately connecting the inductor to an input voltage source and a low impedance source and a controller, wherein the controller is configured to determine whether an undesirable limit cycle exists, send a control signal to the switching system to connect the inductor to the input voltage source and place the inductor in a charge state at a first time during each timing cycle, sense a current across the inductor, when an undesirable limit cycle does not exist, send a control signal within one timing cycle from the first time to the switching system to disconnect the inductor from the input voltage and place the inductor in a discharge state if the current across the inductor reaches a threshold value, and when an undesirable limit cycle does exist, send a control signal after at least one timing cycle from the first time to the switching system to disconnect the inductor from the input voltage and place the inductor in a discharge state.

Preferably, the controller is configured to determine whether an undesirable limit cycle exists by determining whether the inductor is kept in a charge state for greater than one time cycle T. In one aspect, the controller is configured to determine whether an undesirable limit cycle exists comprises determining whether the inductor is already switched to a charge state at the first time.

Also preferably, the controller is configured to determine a period NT of the undesirable limit cycle. In one embodiment, the controller is configured to determine the period NT of the undesirable limit cycle by counting a number of consecutive timing cycles for which the inductor is already switched to a charge state at the first time of each timing cycle. Further, the controller is preferably configured to disable the sending of the control signal until N−1 timing cycles have occurred when an undesirable limit cycle exists.

In another aspect of the disclosure, the controller is configured to determine when the ratio of a rate during the charge state to a rate during the discharge state is greater than one. The controller can also be configured to determine whether a time the inductor is in the discharge state is greater than one time cycle.

### BRIEF DESCRIPTION OF THE DRAWINGS

Further features and advantages will become apparent from the following and more particular description of the preferred embodiments of the invention, as illustrated in the accompanying drawing, and in which like referenced characters generally refer to the same parts or elements throughout the views, and in which:

FIG. 1 depicts the limit cycle of current across the inductor of a current mode switching regulator;

FIG. 2 is a schematic diagram of the main functional components of a current mode, pulse width modulated regulator, according to the invention; and

FIG. 3 depicts an undesirable limit cycle of current across the inductor of a current mode switching regulator.

### DETAILED DESCRIPTION OF THE INVENTION

This disclosure involves methods and systems for suppressing undesired limit cycles in switching regulators by determining when a limit cycle causes the inductor to charge for a time greater than the clock period and destabilizing such cycles.

At the outset, it is to be understood that this disclosure is not limited to particularly exemplified materials, methods or structures as such may, of course, vary. Thus, although a number of materials and methods similar or equivalent to those described herein can be used in the practice of embodiments of this disclosure, the preferred materials and methods are described herein.

It is also to be understood that the terminology used herein is for the purpose of describing particular embodiments of this disclosure only and is not intended to be limiting.

Unless defined otherwise, all technical and scientific terms used herein have the same meaning as commonly understood by one having ordinary skill in the art to which the disclosure pertains.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a digital processing system, or similar electronic computing device, that manipulates and transforms data represented as physical (electronic) quantities within the system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise.

Turning now to FIG. 2, a current mode, PWM regulator 20 is shown schematically in a configuration that provides an output voltage lower than the input voltage, also known as a buck converter. As will be appreciated, the techniques of this disclosure can be applied to other regulators, including boost, buck-boost, and others. Controller 22 operates switches Sₚ 24 and S 26 to alternately connect inductor L 28 to the input voltage Vᵢₙ 30 and ground 32, respectively. As will be recognized, in some embodiments, a different low impedance source can be used in place of ground 32. Switches Sₚ 24 and S 26 are typically large transistors responsive to control signals sent by controller 22, although other suitable switching systems or configurations can be used as desired. Capacitor C 34 acts as a voltage source to the load when inductor L 28 is charging to smooth the output.

Controller 22 is driven by an oscillator or other suitable clock source, and under normal operation, connects inductor L 28 to Vᵢₙ 30 at the start of each clock cycle. Inductor L 28 and capacitor C 34 function as a low pass filter, providing an output voltage Vₒᵤₜ 36. An error signal generated by subtracting V_{ref} 38 from Vₒᵤₜ 36 is used to generate a proportional output current Iₒᵤₜ 40 across inductor L 28, driving Vₒᵤₜ 36 to approach V_{ref} 38. Feedback control to modulate the pulse width occurs when Iₒᵤₜ 40 reaches a current limit threshold. Controller 22 is configured with a comparator or other suitable circuitry to determine when the threshold current Iₗᵢₘ is met and then set switches Sₚ 24 and S 26 to connect inductor L 28 to ground 32.

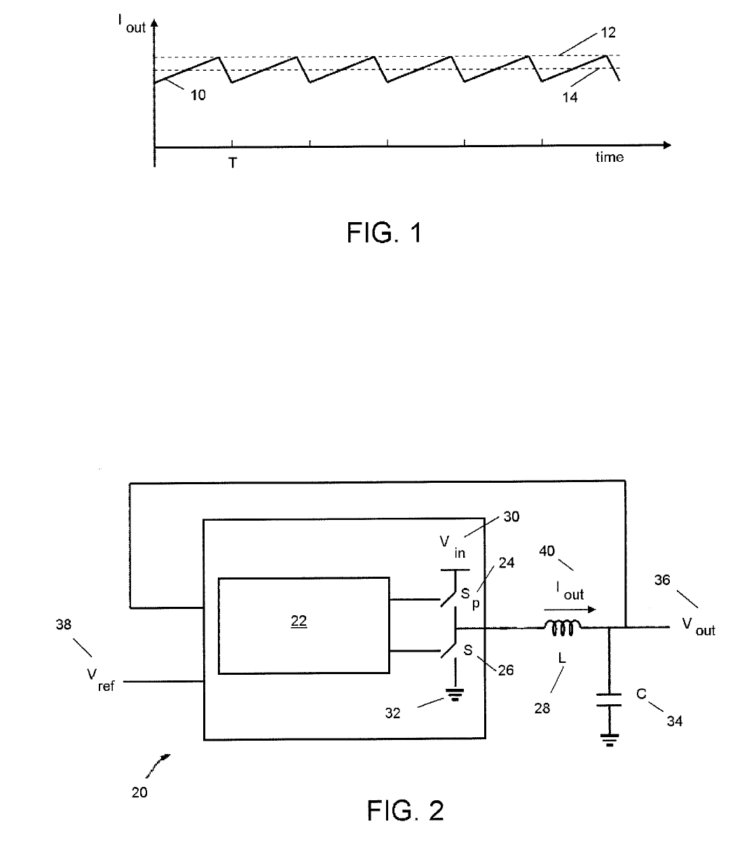

As discussed above, FIG. 1 depicts an exemplary limit cycle showing the waveform 10 of current across the inductor of a current mode, PWM regulator, such as inductor L 28 of regulator 20. At the beginning of each clock cycle T, controller 22 closes switch Sₚ 24 to connect to Vᵢₙ 30 and opens switch S 26, placing inductor L 28 into a charge state wherein the current across inductor L 28 ramps up as shown. When Iₗᵢₘ₁ 12 is met, controller 22 opens switch Sₚ 24 and closes switch S 26 to connect to ground 32, placing inductor L 28 into a discharge state wherein the current across inductor L 28 falls. As shown, the current across inductor L 28 ramps down until the start of the next clock cycle when controller 22 sets the output, connecting inductor L 28 to Vᵢₙ 30 again, resulting in the sawtooth waveform 10. This waveform generates the average output current I_{avg} 14. As a practical matter, it is often convenient to initiate the process by setting inductor L 28 to charge at the rising edge of each clock cycle as shown. However, one of skill in the art will recognize that other timing schemes can be employed so long as the process is initiated at a regular point during each clock cycle.

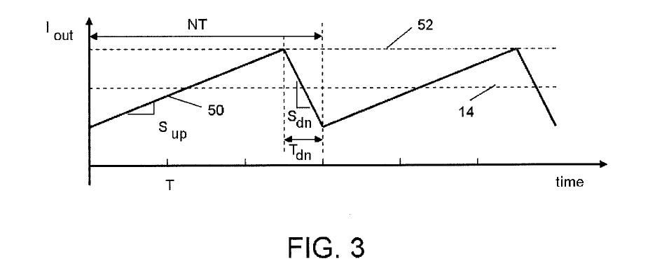

The limit cycle shown in FIG. 1 is a desirable limit cycle having a period equal to the clock cycle T. However, operating conditions can result in additional stable limit cycles that are not desirable. FIG. 3 shows an example of current waveform 50 resulting from an undesirable limit cycle, having a correspondingly higher current limit threshold, Iₗᵢₘ₂ 52. Even though the average output current I_{avg} 14 is the same, the charge ramp occurs across more than one clock cycle. In the example shown, output is set high and the inductor is charged during the first clock cycle of the period. However, since Iₗᵢₘ₂ 52 has not yet been met, the inductor does not get switched to ground during the first clock cycle. At the start of the next clock cycle, the controller signals to set the switches to connect the inductor to the input voltage, but since the inductor was never switched out, there is no change in state and the inductor continues to charge. As shown, Iₗᵢₘ₂ 52 has not been reached at the end of the second clock period either, so the inductor continues to charge. Finally, Iₗᵢₘ₂ 52 is met during the third clock cycle and the controller resets the output to low by switching the inductor to ground so that it discharges as shown until the start of the next clock cycle, when the controller again sets it to charge.

The limit cycle shown in FIG. 3 is characterized by having a period of NT, charging at the rate sᵤₚ and discharging at the rate s_{dn} with a discharge time denoted T_{dn}. As can be appreciated, a number of different stable limit cycles are possible, but only values less than a clock cycle are possible for T_{dn} as the controller sets the inductor to charge at the beginning of each clock cycle, preventing the inductor from discharging for more than a clock cycle.

FIG. 3 depicts that a stable limit cycle requires the net current charge to equal the net current discharge, as represented by

(NT−T_{dn})|sᵤₚ|=T_{dn}|s_{dn}|

Since T_{dn} must be less than T as discussed above, it follows that

$$N < \frac{\vert {s}_{dn} \vert}{\vert {s}_{up} \vert} + 1 \qquad ( 2 )$$

The ratio of the discharge rate to charge rate is indicative of whether undesirable limit cycles can exist. From equation (2), it can be seen that when rate ratio

$$\frac{\vert {s}_{d n} \vert}{\vert {s}_{u p} \vert}$$

is less than 1, the only possible integer value for N is 1, resulting in the desirable limit cycle having a period equal to the clock cycle. However, when the rate ratio is greater than 1, undesirable parasitic limit cycles are possible. For example, when the ratio of rate of discharge to rate of charge is 2.5, limit cycles having a period of greater than a clock cycle, such as 2T or 3T, are possible.

Further characteristics of waveform 50 shown in FIG. 3 include the rate of charge and discharge such that

$$\begin{matrix}{s}_{u p} = \frac{1}{{L}_{o u t}} ( {V}_{in} - {V}_{o u t} ) \\ and & ( 3 ) \\ {s}_{d n} = \frac{1}{{L}_{o u t}} ( {V}_{o u t} ) & ( 4 )\end{matrix}$$

where Vᵢₙ and Vₒᵤₜ are the input and the output voltages of the regulator and Lₒᵤₜ is the inductor. Correspondingly, the parameter of the rate ratio being less than 1 leads to the relationship

$${V}_{i n} < \frac{{V}_{o u t}}{2} \qquad ( 5 )$$

One of skill in the art will recognize that equation (5) is a well known characteristic that can be employed in the design of switching regulators to minimize sub-harmonic oscillations. However, undesirable additional limit cycles having a period greater than one clock cycle are still possible even when the nominal values of Vᵢₙ and Vₒᵤₜ satisfy this condition. For example, in high power switching regulators, significant IR drops can occur in the input and output lines. Similarly, the inductor can also experience IR drops due to its effective series resistance (ESR). Under these conditions, limit cycles having a periodicity greater than one clock cycle are possible. Further, when values of Vᵢₙ, and Vₒᵤₜ do not satisfy the condition, conventional regulators often impart a compensating ramp into the current waveform to suppress sub-harmonic oscillations. However, such compensating ramps do not prevent the undesirable stable limit cycles discussed above.

Limit cycles having a period greater than a single clock cycle are undesirable as they tend to result in greater ripples in the output voltage due to the higher current developed in the inductor. The greater current also puts additional strain on the inductor and can lead to reliability problems. The presence of one or more additional stable limit cycles also affects the switching noise frequency, undermining attempts to compensate for or otherwise control the noise.

Accordingly, in one aspect of this disclosure, controller 22 is configured to suppress limit cycles having a period greater than one clock cycle. Specifically, at the start of each clock cycle, controller 22 determines if inductor L 28 is currently switched to input voltage Vᵢₙ 30. If inductor L 28 has been reset and switched to ground 32 in the previous cycle, then controller 22 operates normally by operating switches Sₚ 24 and S 26 to connect inductor L 28 to the input voltage Vᵢₙ 30. However, if inductor L 28 is still switched to Vᵢₙ 30 as the start of a clock cycle, controller 22 disables the output reset function for a period of K clock cycles, preventing the inductor L 28 from being switched to ground 32 so that it continues to charge. Since a greater current develops across inductor L 28, a correspondingly longer discharge T_{dn} is required for a stable limit cycle. As described above, though, stable limit cycles having a T_{dn} value exceeding one clock cycle are not possible.

Thus, by increasing the current across inductor L 28 to create a resulting T_{dn} that cannot be supported, these undesirable limit cycles are suppressed. Preferably, controller 22 is configured to generate the requisite increase in current across inductor L 28 by not resetting the inductor for a period of K cycles, wherein K equals or exceeds N−1. In other words, controller 22 disables the sending of the control signal until N−1 timing cycles have occurred.

A number of suitable techniques for determining the presence and characteristics of stable, but undesirable limit cycles can be employed. For example, controller 22 can be configured to implement the output reset disabling after the passage of a sufficient number of clock cycles to determine that an undesirable limit cycle has stabilized and to determine the corresponding period of that cycle.

As will be appreciated, the above aspects of operating controller 22 can readily be implemented using conventional digital logic techniques in any number of suitable manners.

Described herein are presently preferred embodiments, however, one skilled in the art that pertains to the present invention will understand that the principles of this disclosure can be extended easily with appropriate modifications to other applications.

What is claimed is:

1. A method for controlling a switching regulator having an inductor coupled to a load and a clock having regular timing cycles T, comprising the steps of:
a) determining whether an undesirable limit cycle exists;
b) sending a control signal to switch the inductor to a charge state at a first time during each timing cycle;
c) sensing a current across the inductor;
d) when an undesirable limit cycle does not exist, sending a control signal within one timing cycle from the first time to switch the inductor to a discharge state if the current across the inductor reaches a threshold value; and
e) when an undesirable limit cycle does exist, sending a control signal after at least one timing cycle from the first time to switch the inductor to a discharge state.

2. The method of claim 1, wherein the step of determining whether an undesirable limit cycle exists comprises determining whether the inductor is kept in a charge state for greater than one time cycle T.

3. The method of claim 2, wherein the step of determining whether an undesirable limit cycle exists comprises determining whether the inductor is already switched to a charge state at the first time.

4. The method of claim 3, wherein the step of determining whether an undesirable limit cycle exists further comprises determining a period NT of the undesirable limit cycle.

5. The method of claim 4, wherein the step of determining the period NT of the undesirable limit cycle comprises counting a number of consecutive timing cycles for which the inductor is already switched to a charge state at the first time of each timing cycle.

6. The method of claim 4, wherein the step of sending a control signal after at least one timing cycle from the first time to switch the inductor to a discharge state comprises disabling the sending of the control signal until N−1 timing cycles have occurred.

7. The method of claim 1, wherein the step of determining whether an undesirable limit cycle exists includes determining when the ratio of a rate during the charge state to a rate during the discharge state is greater than one.

8. The method of claim 1, wherein the step of determining whether an undesirable limit cycle exists includes determining whether a time the inductor is in the discharge state is greater than one time cycle.

9. A switching regulator comprising an inductor coupled to a load, a clock having regular timing cycles T, a switching system for alternately connecting the inductor to an input voltage source and a low impedance source and a controller, wherein the controller is configured to:
a) determine whether an undesirable limit cycle exists;
b) send a control signal to the switching system to connect the inductor to the input voltage source and place the inductor in a charge state at a first time during each timing cycle;
c) sense a current across the inductor;
d) when an undesirable limit cycle does not exist, send a control signal within one timing cycle from the first time to the switching system to disconnect the inductor from the input voltage and place the inductor in a discharge state if the current across the inductor reaches a threshold value; and
e) when an undesirable limit cycle does exist, send a control signal after at least one timing cycle from the first time to the switching system to disconnect the inductor from the input voltage and place the inductor in a discharge state.

10. The regulator of claim 9, wherein the controller is configured to determine whether an undesirable limit cycle exists by determining whether the inductor is kept in a charge state for greater than one time cycle T.

11. The regulator of claim 10, wherein the controller is configured to determine whether an undesirable limit cycle exists comprises determining whether the inductor is already switched to a charge state at the first time.

12. The regulator of claim 11, wherein the controller is configured to determine a period NT of the undesirable limit cycle.

13. The regulator of claim 12, wherein the controller is configured to determine the period NT of the undesirable limit cycle by counting a number of consecutive timing cycles for which the inductor is already switched to a charge state at the first time of each timing cycle.

14. The regulator of claim 12, wherein the controller is configured to disable the sending of the control signal until N−1 timing cycles have occurred when an undesirable limit cycle exists.

15. The regulator of claim 9, wherein the controller is configured to determine when the ratio of a rate during the charge state to a rate during the discharge state is greater than one.

16. The regulator of claim 9, wherein the controller is configured to determine whether a time the inductor is in the discharge state is greater than one time cycle.
